(19) United States
(12) Patent Application Publication
(10) Pub. No.: US 2015/0129207 A1
(43) Pub. Date: May 14, 2015

(54) METHODS UTILIZING POLYAMIDE-POLY(PHENYLENE ETHER) COMPOSITIONS

(71) Applicant: SABIC Global Technologies B.V., Bergen op Zoom (NL)

(72) Inventors: Brian Bastuba, Chicago, IL (US); Lakshmikant Suryakant Powale, Selkirk, NY (US); Arno C. Hagenaars, Bergen op Zoom (NL); Robert John Hossan, Delmar, NY (US)

(21) Appl. No.: 14/591,110

(22) Filed: Jan. 7, 2015

Related U.S. Application Data
(60) Provisional application No. 62/097,688, filed on Dec. 30, 2014.

(51) Int. Cl. C09K 8/80; C09K 8/52; E21B 43/26; E21B 17/02; E21B 33/138; E21B 43/04; E21B 47/00; C09K 8/588; E21B 43/267

(52) U.S. Cl. CPC C09K 8/80; C09K 8/588; C09K 8/52; E21B 43/26; E21B 43/267; E21B 33/138; E21B 43/04; E21B 47/00; E21B 17/02
USPC 166/250.01; 166/308.2; 166/280.1; 166/292; 166/278; 166/378; 166/307

(57) ABSTRACT

A polyamide-poly(phenylene ether) composition includes, based on the total weight of the composition, 35 to 80 weight percent of polyamide, and 20 to 65 weight percent of a poly(phenylene ether). The polyamide-poly(phenylene ether) composition is utilized in a variety of methods, including methods applicable to the oil and gas industry.

### BACKGROUND OF THE INVENTION

Polyamides or “nylons” are polymers used to make a wide variety of consumer goods, including women's stockings, parachutes, ropes, and components of automotive tires. Blends of polyamides with poly(phenylene ether)s combine the dimensional stability, low water absorption, and heat resistance of the poly(phenylene ether) with the chemical resistance and high melt flow of the polyamide.

Recently, polyamide-poly(phenylene ether) blends have been used to form low density proppants for hydraulic fracturing. See, for example, U.S. Patent Application Publication No. US 2014/0349896 A1 of Bastuba et al. However, polyamide-poly(phenylene ether) blends have not achieved widespread application in other aspects of the oil and gas industry.

### BRIEF SUMMARY OF EMBODIMENTS OF THE INVENTION

One embodiment is a method of utilizing a polyamide-poly(phenylene ether) composition, wherein the method is selected from the group consisting of
a method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon;
a method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids;
a method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone;
a method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3;
a method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and introducing a liquid hydrocarbon into the fracture, thereby dissolving the proppant shell;
a method of forming a gravel pack, the method comprising combining the polyamide-poly(phenylene ether) composition, a viscosifier, and a solvent to form a degradable polymer composition; allowing the degradable polymer composition to at least partially plasticize; and applying sufficient shear to the degradable polymer composition to induce formation of a gravel pack from the degradable polymer composition;
a method for monitoring a parameter of a subterranean formation, the method comprising introducing a sensing tool to a wellbore, wherein the sensing tool comprises a generally tubular body and is configured to detect a parameter of the subterranean formation; positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device;
a method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size;
a method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent to the tapered face; and contacting the swellable material with a swelling fluid, thereby swelling the swellable material and preventing substantially all fluids from flowing past the swellable material after the swellable material has swelled;
a method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component;
a method of treating a subterranean formation penetrated by a wellbore comprising a formation surface, the method comprising injecting into the formation a fluid comprising a viscosified fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection;
a method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators;
   wherein the polyamide-poly(phenylene ether) composition comprises, based on the total weight of the polyamide-poly(phenylene ether) composition, 35 to 80 weight percent of a polyamide, and 20 to 65 weight percent of a poly(phenylene ether).

This and other embodiments are described in detail below.

### DETAILED DESCRIPTION OF THE INVENTION

The present inventors have determined that a polyamide-poly(phenylene ether) composition containing 35 to 80 weight percent polyamide, and 20 to 65 weight percent poly(phenylene ether) has a wide variety of uses, especially uses in the oil and gas industry.

The components used to prepare the polyamide-poly(phenylene ether) composition include a polyamide. Suitable polyamides include polyamide-6, polyamide-6,6, polyamide-4,6, polyamide-11, polyamide-12, polyamide-6,10, polyamide-6,12, polyamide-6/6,6, polyamide-6/6,12, polyamide-MXD,6 (where “MXD” is meta-xylylenediamine), polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, polyamide-9T, and combinations thereof In some embodiments, the polyamide is polyamide-6, polyamide-6,6, or a combination thereof In some embodiments, the polyamide is polyamide-6,6.

The polyamide-poly(phenylene ether) composition comprises the polyamide in an amount of 35 to 80 weight percent, based on the total weight of the polyamide-poly(phenylene ether) composition. Within this range, the polyamide amount can be 40 to 70 weight percent, more specifically 50 to 69.5 weight percent.

In addition to the polyamide, the components used to prepare the polyamide-poly(phenylene ether) composition include a poly(phenylene ether). Suitable poly(phenylene ether)s include those comprising repeating structural units having the formula

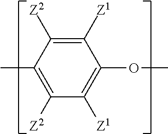

wherein each occurrence of Z¹ is independently halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl; and each occurrence of Z² is independently hydrogen, halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(phenylene ether) has an intrinsic viscosity of 0.25 to 1 deciliter per gram measured by Ubbelohde viscometer at 25° C. in chloroform. Within this range, the poly(phenylene ether) intrinsic viscosity can be 0.3 to 0.65 deciliter per gram, more specifically 0.35 to 0.5 deciliter per gram, even more specifically 0.4 to 0.5 deciliter per gram.

In some embodiments, the poly(phenylene ether) is essentially free of incorporated diphenoquinone residues. In the context, “essentially free” means that less than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues). For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone. However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with 1 to 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Pat. No. 8,025,158 to Delsman et al. In an alternative approach utilizing the temperature-dependent solubility of diphenoquinone in toluene, a toluene solution containing diphenoquinone and poly(phenylene ether) can be adjusted to a temperature of 25° C., at which diphenoquinone is poorly soluble but the poly(phenylene ether) is soluble, and the insoluble diphenoquinone can be removed by solid-liquid separation (e.g., filtration).

In some embodiments, the poly(phenylene ether) comprises 2,6-dimethyl-1,4-phenylene ether units, 2,3,6-trimethyl-1,4-phenylene ether units, or a combination thereof In some embodiments, the poly(phenylene ether) comprises a poly(2,6-dimethyl-1,4-phenylene ether). In some embodiments, the poly(phenylene ether) comprises a poly(2,6-dimethyl-1,4-phenylene ether) having an intrinsic viscosity of 0.35 to 0.5 deciliter per gram, specifically 0.35 to 0.46 deciliter per gram, measured by Ubbelohde viscometer at 25° C. in chloroform.

The poly(phenylene ether) can comprise molecules having aminoalkyl-containing end group(s), typically located in a position ortho to the hydroxyl group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

The polyamide-poly(phenylene ether) composition comprises the poly(phenylene ether) in an amount of 20 to 65 weight percent, based on the total weight of the polyamide-poly(phenylene ether) composition. Within this range, the poly(phenylene ether) amount can be 25 to 55 weight percent, specifically 30 to 49.5 weight percent, more specifically 30 to 45 weight percent.

In some embodiments, a compatibilizing agent is used to facilitate formation of a compatibilized blend of the polyamide and the poly(phenylene ether). As used herein, the term “compatibilizing agent” refers to a polyfunctional compound that interacts with the poly(phenylene ether), the polyamide, or both. This interaction can be chemical (for example, grafting) and/or physical (for example, affecting the surface characteristics of the dispersed phases). In either instance the resulting polyamide-poly(phenylene ether) blend exhibits improved compatibility, particularly as evidenced by enhanced impact strength, mold knit line strength, and/or tensile elongation. As used herein, the expression “compatibilized blend” refers to compositions that have been physically and/or chemically compatibilized with a compatibilizing agent, as well as blends of poly(phenylene ether)s and polyamides that are compatibilized without the use of a compatibilizing agent, as is the case, for example, when compatibilization is derived from compatibility-enhancing dibutylaminomethyl substituents on the poly(phenylene ether).

Examples of compatibilizing agents that can be employed include liquid diene polymers, epoxy compounds, oxidized polyolefin wax, quinones, organosilane compounds, polyfunctional compounds, functionalized poly(phenylene ether)s, and combinations thereof Compatibilizing agents are further described in U.S. Pat. No. 5,132,365 to Gallucci, and U.S. Pat. Nos. 6,593,411 and 7,226,963 to Koevoets et al.

In some embodiments, the compatibilizing agent comprises a polyfunctional compound. Polyfunctional compounds that can be employed as a compatibilizing agent are typically of three types. The first type of polyfunctional compound has in the molecule both (a) a carbon-carbon double bond or a carbon-carbon triple bond and (b) at least one carboxylic acid, anhydride, amide, ester, imide, amino, epoxy, orthoester, or hydroxyl group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, or fumaric acid; dichloro maleic anhydride; maleic acid amide; unsaturated dicarboxylic acids (for example, acrylic acid, butenoic acid, methacrylic acid, ethylacrylic acid, pentenoic acid, decenoic acids, undecenoic acids, dodecenoic acids, and linoleic acid); esters, acid amides or anhydrides of the foregoing unsaturated carboxylic acids; unsaturated alcohols (for example, alkanols, crotyl alcohol, methyl vinyl carbinol, 4-pentene-1-ol, 1,4-hexadiene-3-ol, 3-butene-1,4-diol, 2,5-dimethyl-3-hexene-2,5-diol, and alcohols of the formula CₙH₂ₙ₋₅OH, CₙH₂ₙ₋₇OH and CₙH₂ₙ₋₉ OH, wherein n is a positive integer from 10 to 30); unsaturated amines resulting from replacing from replacing the —OH group(s) of the above unsaturated alcohols with —NH₂ group(s); functionalized diene polymers and copolymers; and combinations comprising one or more of the foregoing. In some embodiments, the compatibilizing agent comprises maleic anhydride and/or fumaric acid.

The second type of polyfunctional compatibilizing agent has both (a) a group represented by the formula (OR) wherein R is hydrogen or an alkyl, aryl, acyl or carbonyl dioxy group and (b) at least two groups each of which can be the same or different selected from carboxylic acid, acid halide, anhydride, acid halide anhydride, ester, orthoester, amide, imido, amino, and various salts thereof Typical of this group of compatibilizing agents are the aliphatic polycarboxylic acids, acid esters, and acid amides represented by the formula:

(R¹O)ₘR′(COOR^{II})ₙ(CONR^{III}R^{IV})ₛ

wherein R′ is a linear or branched chain, saturated aliphatic hydrocarbon having 2 to 20, or, more specifically, 2 to 10, carbon atoms; R¹ is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} ' cannot be aryl when the respective substituent has less than 6 carbon atoms.

Suitable polycarboxylic acids include, for example, citric acid, malic acid, and agaricic acid, including the various commercial forms thereof, such as for example, the anhydrous and hydrated acids; and combinations comprising one or more of the foregoing. In some embodiments, the compatibilizing agent comprises citric acid. Illustrative of esters useful herein include, for example, acetyl citrate, monostearyl and/or distearyl citrates. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivatives include the salts thereof, including the salts with amines and the alkali and alkaline metal salts. Examples of suitable salts include calcium malate, calcium citrate, potassium malate, and potassium citrate.

The third type of polyfunctional compatibilizing agent has in the molecule both (a) an acid halide group and (b) at least one carboxylic acid, anhydride, ester, epoxy, orthoester, or amide group, preferably a carboxylic acid or anhydride group. Examples of compatibilizing agents within this group include trimellitic anhydride acid chloride, chloroformyl succinic anhydride, chloroformyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In some embodiments, the compatibilizing agent comprises trimellitic anhydride acid chloride.

In some embodiments, the compatibilizing agent is selected from the group consisting of citric acid, maleic acid, fumaric acid, maleic anhydride, and combinations thereof.

The foregoing compatibilizing agents can be added directly to the melt blend or pre-reacted with either or both of the poly(phenylene ether) and the polyamide, as well as with any other resinous materials employed in the preparation of the compatibilized polyamide-poly(phenylene ether) blend. With many of the foregoing compatibilizing agents, particularly the polyfunctional compounds, even greater improvement in compatibility is found when at least a portion of the compatibilizing agent is pre-reacted, either in the melt or in a solution of a suitable solvent, with all or a part of the poly(phenylene ether). It is believed that such pre-reacting may cause the compatibilizing agent to react with and consequently functionalize the poly(phenylene ether). For example, the poly(phenylene ether) can be pre-reacted with maleic anhydride to form an anhydride-functionalized poly(phenylene ether) that has improved compatibility with the polyamide compared to a non-functionalized poly(phenylene ether).

When a compatibilizing agent is employed in the preparation of the polyamide-poly(phenylene ether) composition, the amount used will be dependent upon the specific compatibilizing agent chosen and the specific polymeric system to which it is added. In some embodiments, the compatibilizing agent amount is 0.1 to 4 weight percent, specifically 0.2 to 3 weight percent, more specifically 0.5 to 2 weight percent, based on the total weight of the polyamide-poly(phenylene ether) composition.

The polyamide-poly(phenylene ether) composition can, optionally, further comprise an impact modifier. Impact modifiers can be block copolymers containing alkenyl aromatic repeating units, for example, A-B diblock copolymers and A-B-A triblock copolymers having of one or two alkenyl aromatic blocks A (blocks having alkenyl aromatic repeating units), which are typically styrene blocks, and a rubber block, B, which is typically an isoprene or butadiene block. The butadiene block can be partially or completely hydrogenated. Mixtures of these diblock and triblock copolymers can also be used as well as mixtures of non-hydrogenated copolymers, partially hydrogenated copolymers, fully hydrogenated copolymers and combinations of two or more of the foregoing. A-B and A-B-A copolymers include, but are not limited to, polystyrene-polybutadiene, polystyrene-poly(ethylene-propylene) (SEP), polystyrene-polyisoprene, poly(a-methylstyrene)-polybutadiene, polystyrene-polybutadiene-polystyrene (SBS), polystyrene-poly(ethylene-butylene)-polystyrene (SEBS), polystyrene-poly(ethylene-propylene)-polystyrene, polystyrene-polyisoprene-polystyrene (SIS), poly(alpha-methylstyrene)-polybutadiene-poly(alpha-methylstyrene), and polystyrene-poly(ethylene-propylene-styrene)-polystyrene. Mixtures of the aforementioned block copolymers are also useful. Such A-B and A-B-A block copolymers are available commercially from a number of sources, including Phillips Petroleum under the trademark SOLPRENE™, Kraton Performance Polymers Inc. under the trademark KRATON™, Dexco under the trademark VECTOR™, Asahi Kasai under the trademark TUFTEC™, Total Petrochemicals under the trademarks FINAPRENE™ and FINACLEAR™, Dynasol under trademark CALPRENE™, and Kuraray under the trademark SEPTON™. In some embodiments, the impact modifier comprises a polystyrene-polybutadiene-polystyrene triblock copolymer.

Another type of impact modifier is a rubber-modified polystyrene. The rubber-modified polystyrene comprises polystyrene and polybutadiene. Rubber-modified polystyrenes are sometimes referred to as “high-impact polystyrenes” or “HIPS”. In some embodiments, the rubber-modified polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the rubber-modified polystyrene has an effective gel content of 10 to 35 percent. Suitable rubber-modified polystyrenes are commercially available as, for example, HIPS NORYL™ Resin from SABIC Innovative Plastics.

Another type of impact modifier is essentially free of alkenyl aromatic repeating units and comprises one or more moieties selected from the group consisting of carboxylic acid, anhydride, epoxy, oxazoline, and orthoester. Essentially free is defined as having alkenyl aromatic units present in an amount less than 5 weight percent, or, more specifically, less than 3 weight percent, or, even more specifically less than 2 weight percent, based on the total weight of the block copolymer. When the impact modifier comprises a carboxylic acid moiety the carboxylic acid moiety can be neutralized with an ion, preferably a metal ion such as zinc or sodium. It can be an alkylene-alkyl(meth)acrylate copolymer and the alkylene groups can have 2 to 6 carbon atoms and the alkyl group of the alkyl(meth)acrylate can have 1 to 8 carbon atoms. This type of polymer can be prepared by copolymerizing an olefin, for example, ethylene and propylene, with various (meth)acrylate monomers and/or various maleic-based monomers. The term (meth)acrylate refers to both the acrylate as well as the corresponding methacrylate analogue. Included within the term (meth)acrylate monomers are alkyl(meth)acrylate monomers as well as various (meth)acrylate monomers containing at least one of the aforementioned reactive moieties. In a one embodiment, the copolymer is derived from ethylene, propylene, or mixtures of ethylene and propylene, as the alkylene component; butyl acrylate, hexyl acrylate, or propyl acrylate as well as the corresponding alkyl(methyl)acrylates, for the alkyl (meth)acrylate monomer component, with acrylic acid, maleic anhydride, glycidyl methacrylate or a combination thereof as monomers providing the additional reactive moieties (i.e., carboxylic acid, anhydride, epoxy). Exemplary impact modifiers are commercially available from a variety of sources including DuPont under the trademarks ELVALOY™ PTW, SURLYN™, and FUSABOND™.

In some embodiments, the impact modifier comprises a rubber-modified polystyrene, a polystyrene-polybutadiene-polystyrene triblock copolymer, or a combination thereof.

When present in the polyamide-poly(phenylene ether) composition, the impact modifier is used in an amount of 10 to 35 weight percent, based on the total weight of the composition. Within this range, the impact modifier amount can be 15 to 30 weight percent, specifically 20 to 25 weight percent. In some embodiments, the impact modifier comprises 10 to 20 weight percent of a rubber-modified polystyrene and 3 to 13 weight percent of a polystyrene-polybutadiene-polystyrene triblock copolymer.

The polyamide-poly(phenylene ether) composition can, optionally, further comprise a mineral filler. Suitable mineral fillers include, for example, wollastonite, talc, mica, clay, and combinations thereof Particularly suitable mineral fillers have a mean particle size of 1 to 4 micrometers. When present in the composition, the mineral filler can be used in an amount of 2 to 40 weight percent, specifically 5 to 30 weight percent, more specifically 10 to 30 weight percent, based on the total weight of the polyamide-poly(phenylene ether) composition.

The polyamide-poly(phenylene ether) composition can, optionally, further comprise one or more additives known in the thermoplastics art. For example, the polyamide-poly(phenylene ether) composition can, optionally, further comprise an additive selected from the group consisting of stabilizers, lubricants, processing aids, dyes, pigments, antioxidants, anti-static agents, mineral oil, metal deactivators, curing agents, crosslinkers, and combinations thereof When present, such additives are typically used in a total amount of less than or equal to 5 weight percent, specifically less than or equal to 3 weight percent, more specifically less than or equal to 1 weight percent, based on the total weight of the polyamide-poly(phenylene ether) composition.

In a very specific embodiment, the polyamide-poly(phenylene ether) composition is the product of melt blending components comprising 50 to 69.5 weight percent of polyamide-6,6, 30 to 49.5 weight percent of poly(2,6-dimethyl-1,4-phenylene ether), and 0.5 to 2 weight percent of a compatibilizing agent for the polyamide-6,6 and the poly(2,6-dimethyl-1,4-phenylene ether).

One method of utilizing the polyamide-poly(phenylene ether) composition is a method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon. The first proppant and the second proppant can be used in a volume ratio of 1:9 to 9:1, specifically 1:4 to 4:1, more specifically 1:2 to 2:1. Examples of suitable second proppants include sand (silicon dioxide), bauxite, glasses, ceramic materials, walnut shells, and plastics having a negligible solubility in liquid hydrocarbon.

Another method of utilizing the polyamide-poly(phenylene ether) composition is a method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids. Suitable displacement fluids include, for example, an aqueous-based fluid (e.g., fresh water, salt water, brine, or seawater), a hydrocarbon-based fluid (e.g., kerosene, xylene, toluene, diesel, or oil), a foamed fluid (e.g., a liquid that comprises a gas), a gas (e.g., nitrogen or carbon dioxide), or a combination thereof. The displacement fluid can, optionally, include a viscosity modifier to increase the viscosity of the displacement fluid. Suitable viscosity modifiers include, for example, guar gums (e.g., hydroxyethyl guar, hydroxypropyl guar, carboxymethyl guar, carboxymethythydroxyethyl guar, and carboxymethylhydroxypropyl guar (“CMHPG”)), cellulose derivatives (e.g., hydroxyethyl cellulose, carboxyethylcellulose, carboxymethylcellulose, and carboxymethylhydroxyethylcellulose), xanthan, seleroglucan, diutan, acrylamide/2-(methacryloyloxy)ethyltrimethylammonium methyl sulfate copolymers, and combinations thereof. When present, the viscosity modifier can be used in an amount of 0.1 to 10 weight percent, based on the weight of the displacement fluid. In some embodiments, the displacement fluid comprises a second proppant comprising particles larger than those of the proppant comprising the polyamide-poly(phenylene ether) composition.

Another method of utilizing the polyamide-poly(phenylene ether) composition is a method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone. Fluids capable of swelling the particles comprising the polyamide-poly(phenylene ether) composition include aqueous-based fluids (e.g., fresh water, salt water, brine, and seawater), hydrocarbon-based fluids (e.g., kerosene, xylene, toluene, diesel, and oil), foamed fluids (i.e., liquids that comprise a gas), gases (e.g., nitrogen or carbon dioxide), and combinations thereof.

Another method of utilizing the polyamide-poly(phenylene ether) composition is a method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3. The filling composition can, optionally, comprise a carrier fluid to facilitate pumping the composition into the first fracture zone. A representative carrier fluid comprises water and a viscosity modifier. The filling composition can, optionally further comprise a second particulate having a specific gravity of at least 2.0. Materials useful as second particulates include, for example, sand (silicon dioxide), bauxite, glasses, ceramic materials, walnut shells, and plastics (including filled plastics).

Another method of utilizing the polyamide-poly(phenylene ether) composition is a method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and introducing a liquid hydrocarbon into the fracture, thereby dissolving the proppant shell. The proppant can comprise 20 to 98 weight percent, specifically 50 to 90 weight percent of the core, and 2 to 80 weight percent, specifically 10 to 50 weight percent of the shell. Suitable core materials include, for example, sand (silicon dioxide), bauxite, glasses, ceramic materials, walnut shells, and plastics with negligible hydrocarbon solubility. A carrier fluid, such as water with a viscosity modifier, can be used to introduce the proppant into the fracture. Before the liquid hydrocarbon is introduced into the fracture, the proppant pack is substantially impermeable. After the liquid hydrocarbon is introduced into the fraction, the proppant pack becomes permeable.

Another method of utilizing the polyamide-poly(phenylene ether) composition is a method of forming a gravel pack, the method comprising combining the polyamide-poly(phenylene ether) composition, a viscosity modifier, and a solvent to form a degradable polymer composition; allowing the degradable polymer composition to at least partially plasticize; and applying sufficient shear to the degradable polymer composition to induce formation of a gravel pack from the degradable polymer composition, the gravel pack comprising degradable particulates formed from the degradable polymer composition. The degradable polymer composition can comprise the polyamide-poly(phenylene ether) composition in an amount of 1 to 50 weight percent, specifically 5 to 20 weight percent, based on the total weight of the degradable polymer composition. Suitable viscosity modifiers include, for example, an, succinoglycan, diutan, cellulose, cellulose derivatives, guar, guar derivatives and combinations thereof The degradable polymer composition can comprise the viscosity modifier in an amount of 0.001 to 3 weight percent, specifically 0.01 to 2 weight percent, based on the total weight of the degradable polymer solution. Suitable solvents include, for example, fresh water, salt water, brine, seawater, methanol, ethanol, propylene carbonate, propylene glycol, polyethylene glycol, isopropanol, polyhydric alcohols, glycerol polyethylene oxide, oligomeric lactic acid, citrate esters, tributyl citrate oligomers, triethyl citrate, acetyltributyl citrate, acetyltriethyl citrate, glucose monoesters, partially fatty acid esters, polyethylene glycol monolaurate, triacetin, poly(ε-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol, epoxy derivatives of polypropylene glycol, poly(propylene glycol)dibenzoate, dipropylene glycol dibenzoate, glycerol, ethyl phthalyl ethyl glycolate, poly(ethylene adipate)distearate, di-iso-butyl adipate, and combinations thereof. In some embodiments, the sufficient shear used to induct formation of a gravel pack is a shear of 500 to 50,000 revolutions per minute.

Another method of utilizing the polyamide-poly(phenylene ether) composition is a method for monitoring a parameter of a subterranean formation, the method comprising introducing a sensing tool to a wellbore, wherein the sensing tool comprises a generally tubular body and is configured to detect a parameter of the subterranean formation: positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device. The sensing tool can be, for example, a seismic sensor, a deformation sensor, an accelerometer, or a hydrophone. Swelling of the swellable material typically occurs by absorption of a fluid. Suitable fluids for swelling the polyamide-poly(phenylene ether) composition include aqueous-based fluids (e.g., fresh water, salt water, brine, and seawater), hydrocarbon-based fluids (e.g., kerosene, xylene, toluene, diesel, and oil), foamed fluids (i.e., liquids that comprise a gas), gases (e.g., nitrogen or carbon dioxide), and combinations thereof.

Another method of utilizing the polyamide-poly(phenylene ether) composition is a method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size. The swellable filter medium comprises a filter medium radially surrounded with a swellable material layer. Swelling of the swellable material layer typically occurs by absorption of a fluid. Suitable fluids for swelling the polyamide-poly(phenylene ether) composition include aqueous-based fluids (e.g., fresh water, salt water, brine, and seawater), hydrocarbon-based fluids (e.g., kerosene, xylem, toluene, diesel, and oil), foamed fluids (i.e., liquids that comprise a gas), gases (e.g., nitrogen or carbon dioxide), and combinations thereof Swelling of the swellable material layer causes that layer to contact the wellbore and secure the filter medium within the wellbore.

Another method of utilizing the polyamide-poly(phenylene ether) composition is a method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent to the tapered face; and contacting the swellable material with a swelling fluid, thereby swelling the swellable material and preventing substantially all fluids from flowing past the swellable material after the swellable material has swelled. Suitable swelling fluids for the polyamide-poly(phenylene ether) composition include aqueous-based fluids (e.g., fresh water, salt water, brine, and seawater), hydrocarbon-based fluids (e.g., kerosene, xylem, toluene, diesel, and oil), foamed fluids (i.e., liquids that comprise a gas), gases (e nitrogen or carbon dioxide), and combinations thereof.

Another method of utilizing the polyamide-poly(phenylene ether) composition is a method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component. Suitable swelling fluids for the polyamide-poly(phenylene ether) composition include aqueous-based fluids (e.g., fresh water, salt water, brine, and seawater), hydrocarbon-based fluids (e.g., kerosene, xylene, toluene, diesel, and oil), foamed fluids (i.e., liquids that comprise a gas), gases (e.g., nitrogen or carbon dioxide), and combinations thereof.

Another method of utilizing the polyamide-poly(phenylene ether) composition is a method of treating a subterranean formation penetrated by a wellbore comprising a formation surface, the method comprising injecting into the formation a fluid comprising a viscosified fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection. The viscosified fluid is an aqueous fluid comprising a viscoelastic surfactant. Suitable aqueous fluids include fresh water, salt water, brine, seawater, and combinations thereof Suitable viscoelastic surfactants include, for example, quaternary amines, betaines, carboxylic acids, and amidoamine oxides. Degradation of the solid additive can be effected by thermal degradation, melting, hydrolysis, or a combination thereof.

Another method of utilizing the polyamide-poly(phenylene ether) composition is a method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators.

Although the invention has been described in terms of uses of the polyamide-poly(phenylene ether) composition in the oil and gas industry, it will be understood that the utility of the composition is not limited to this industry. For example, the polyamide-poly(phenylene ether) composition can be used to form tubes and pipes to protect electrical wires and cables, and optical fiber cables; fluid engineering tubes and pipes; foamed articles; multi-layered articles, including films, tapes, sheets, and extruded profiles; use of particles of the polyamide-poly(phenylene ether) composition in rotational molding; filters and filter assembly components; composite membranes, membrane supports, and composite membrane assembly components; furniture and furniture components; and electrical components such as switches, switchgear boxes, and miniature circuit breakers; automotive components; and aviation components.

The invention includes at least the following embodiments.

Embodiment 1: A method of utilizing a polyamide-poly(phenylene ether) composition, wherein the method is selected from the group consisting of
a method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon;
a method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids;
a method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone;
a method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3;
a method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and introducing a liquid hydrocarbon into the fracture, thereby dissolving the proppant shell;
a method of forming a gravel pack, the method comprising combining the polyamide-poly(phenylene ether) composition, a viscosifier, and a solvent to form a degradable polymer composition; allowing the degradable polymer composition to at least partially plasticize; and applying sufficient shear to the degradable polymer composition to induce formation of a gravel pack from the degradable polymer composition;
a method for monitoring a parameter of a subterranean formation, the method comprising introducing a sensing tool to a wellbore, wherein the sensing tool comprises a generally tubular body and is configured to detect a parameter of the subterranean formation; positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device;
a method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size;
a method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent to the tapered face; and contacting the swellable material with a swelling fluid, thereby swelling the swellable material and preventing substantially all fluids from flowing past the swellable material after the swellable material has swelled;
a method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component;
a method of treating a subterranean formation penetrated by a wellbore comprising a formation surface, the method comprising injecting into the formation a fluid comprising a viscosified fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection;
a method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators;
wherein the polyamide-poly(phenylene ether) composition comprises, based on the total weight of the polyamide-poly(phenylene ether) composition, 35 to 80 weight percent of a polyamide, and 20 to 65 weight percent of a poly(phenylene ether).

Embodiment 2: The method of embodiment 1, wherein the polyamide is selected from the group consisting of polyamide-6, polyamide-6,6, polyamide-4,6, polyamide-11, polyamide-12, polyamide-6,10, polyamide-6,12, polyamide-6/6,6, polyamide-6/6,12, polyamide-MXD,6, polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, polyamide-9T, and combinations thereof.

Embodiment 3: The method of embodiment 1, wherein the polyamide comprises polyamide-6,6.

Embodiment 4: The method of any one of embodiments 1-3, wherein the poly(phenylene ether) comprises repeating structural units having the formula

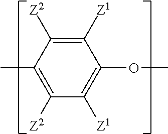

wherein each occurrence of Z¹ is independently halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl; and each occurrence of Z² is independently hydrogen, halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl.

Embodiment 5: The method of any one of embodiments 1-3, wherein the poly(phenylene ether) comprises 2,6-dimethyl-1,4-phenylene ether units, 2,3,6-trimethyl-1,4-phenylene ether units, or a combination thereof.

Embodiment 6: The method of any one of embodiments 1-5, wherein the polyamide-poly(phenylene ether) composition further comprises 10 to 35 weight percent of an impact modifier selected from the group consisting of rubber-modified polystyrenes, polystyrene-polybutadiene-polystyrene triblock copolymers, and combinations thereof.

Embodiment 7: The method of any one of embodiments 1-6, wherein the polyamide-poly(phenylene ether) composition further comprises 5 to 40 weight percent of a mineral filler selected from the group consisting of wollastonite, talc, mica, clay, and combinations thereof.

Embodiment 8: The method of any one of embodiments 1-7, wherein the polyamide-poly(phenylene ether) composition is the product of melt blending components comprising 50 to 69.5 weight percent of polyamide-6,6, 30 to 49.5 weight percent of poly(2,6-dimethyl-1,4-phenylene ether), and 0.5 to 2 weight percent of a compatibilizing agent for the polyamide-6,6 and the poly(2,6-dimethyl-1,4-phenylene ether).

Embodiment 9: The method of any one of embodiments 1-8, wherein the method is the method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon.

Embodiment 10: The method of any one of embodiments 1-8, wherein the method is the method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids.

Embodiment 11: The method of any one of embodiments 1-8, wherein the method is the method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone.

Embodiment 12: The method of any one of embodiments 1-8, wherein the method is the method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3.

Embodiment 13: The method of any one of embodiments 1-8, wherein the method is the method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and introducing a liquid hydrocarbon into the fracture, thereby dissolving the proppant shell.

Embodiment 14: The method of any one of embodiments 1-8, wherein the method is the method of forming a gravel pack, the method comprising combining the polyamide-poly(phenylene ether) composition, a viscosifier, and a solvent to form a degradable polymer composition; allowing the degradable polymer composition to at least partially plasticize; and applying sufficient shear to the degradable polymer composition to induce formation of a gravel pack from the degradable polymer composition.

Embodiment 15: The method of any one of embodiments 1-8, wherein the method is the method for monitoring a parameter of a subterranean formation, the method comprising introducing a sensing tool to a wellbore, wherein the sensing tool comprises a generally tubular body and is configured to detect a parameter of the subterranean formation; positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device.

Embodiment 16: The method of any one of embodiments 1-8, wherein the method is the method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size.

Embodiment 17: The method of any one of embodiments 1-8, wherein the method is the method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent to the tapered face; and contacting the swellable material with a swelling fluid, thereby swelling the swellable material and preventing substantially all fluids from flowing past the swellable material after the swellable material has swelled.

Embodiment 18: The method of any one of embodiments 1-8, wherein the method is the method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component,

Embodiment 19: The method of any one of embodiments 1-8, wherein the method is the method of treating a subterranean formation penetrated by a wellbore comprising a formation surface, the method comprising injecting into the formation a fluid comprising a viscosified fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection.

Embodiment 20: The method of any one of embodiments 1-8, wherein the method is the method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### EXAMPLES 1-5

These examples illustrate variations in the polyamide-poly(phenylene ether) composition. Components used to form the compositions are summarized in Table 1.

TABLE 1

| Component | Description |
|---|---|
| PPE 0.40 | Poly(2,6-dimethyl-1,4-phenylene ether), CAS Reg. No. 25134-01-4, |
| | having an intrinsic viscosity of about 0.40 deciliter per gram as measured in |
| | chloroform at 25° C.; available as PPO ™ 640 from SABIC Innovative |
| | Plastics. |
| PPE 0.45 | Poly(2,6-dimethyl-1,4-phenylene ether), CAS Reg. No. 25134-01-4, |
| | having an intrinsic viscosity of about 0.45 deciliter per gram as measured in |
| | chloroform at 25° C.; available as PPO ™ 800 from SABIC Innovative |
| | Plastics. |
| PA | Polyamide-6,6, CAS Reg. No. 32131-17-2, having a viscosity of about 126 |
| | milliliters/gram measured in 90% formic acid according to ISO 307; |
| | available as STABAMID ™ 24 FE 1 from Rhodia. |
| SBS | Butadiene-styrene block copolymer, CAS Reg. No. 9003-55-8, having a |
| | polystyrene content of about 30% and a melt flow index of about 5 |
| | grams/10 minutes, measured according to ASTM D 1238-10 at 190° C. and |
| | 5 kilogram load; available as CALPRENE ™ 500 from Dynasol. |
| HIPS | Rubber-modified polystyrene, CAS Reg. No. 9003-55-8, have a melt flow |
| | index of about 2.5 grams/10 minutes, measured according to ASTM D |
| | 1238-10 at 200° C. and 5 kilogram load; available as IMPACT ™ 5240 |
| | from Total Petrochemicals. |
| CA | Citric acid, CAS Reg. No. 77-92-9; obtained from Jungbunzlauer. |
| Antioxidant | Octadecyl 3,5-di-tert-butyl-4-hydroxyhydrocinnamate, CAS Reg. No. |
| | 2082-79-3; available as IRGANOX ™ 1076 from BASF. |
| PA/Wollastonite | A wollastonite masterbatch containing 55 weight percent polyamide-6,6, |
| | CAS Reg. No. 32131-17-2, and 45 weight percent wollastonite, CAS Reg. |
| | No. 13983-17-0, the wollastonite having a mean particle size of about 3 |
| | micrometers; available from Clariant. |

The compositions of Examples 1-5 are summarized in Table 2, where component amounts are expressed in units of weight percent based on the total weight of the polyamide-poly(phenylene ether) composition.

For Examples 1-4, the composition was prepared by melt blending the components in a Werner-Pfleiderer 83 millimeter twin-screw extruder operating at 500 rotations/minute and a throughput of about 800 kilograms/hour. All components except the polyamide were added at the feed throat, and polyamide was introduced via a side feeder about one-third down the length of the extruder. The extruder had sixteen temperature zones. The zone temperatures from feed throat to die were 290° C. in zone 1, 300° C. in zones 2-14, and 360° C. in zones 15 and 16. The die plate had 45 2.4 millimeter diameter circular openings. Strands were extruded into a water chamber containing 90° C. water. The strands were pelletized with a BKG Type UWG AH2000 underwater pelletizer having a cutter hub with twenty knives operating at 3200 rpm. Pelletizing of the extrudate while it is still molten yields ellipse-shaped pellets.

For Example 5, the composition was prepared by the procedure of Example 1, except that the wollastonite masterbatch was added with the polyamide in the downstream side feeder.

TABLE 2

| | Ex. 1 | Ex. 2 | Ex. 3 | Ex. 4 | Ex. 5 |
|---|---|---|---|---|---|
| PPE 0.45 | 36.4 | 43.9 | 59.0 | 0.0 | 39.0 |
| PPE 0.40 | 0.0 | 0.0 | 0.0 | 59.0 | 0.0 |
| SBS | 8.3 | 8.3 | 0.0 | 0.0 | 0.0 |
| HIPS | 15.0 | 0.0 | 0.0 | 0.0 | 0.0 |
| CA | 1.0 | 1.0 | 1.0 | 1.0 | 0.7 |
| Antioxidant | 0.3 | 0.3 | 0.0 | 0.0 | 0.3 |
| PA | 39.0 | 46.5 | 40.0 | 40.0 | 15.6 |
| PA/Wollastonite | 0.0 | 0.0 | 0.0 | 0.0 | 44.4 |

1. A method of utilizing a polyamide-poly(phenylene ether) composition, wherein the method is selected from the group consisting of
a method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon;
a method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids;
a method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone;
a method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3;
a method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and introducing a liquid hydrocarbon into the fracture, thereby dissolving the proppant shell;
a method of forming a gravel pack, the method comprising combining the polyamide-poly(phenylene ether) composition, a viscosifier, and a solvent to form a degradable polymer composition; allowing the degradable polymer composition to at least partially plasticize; and applying sufficient shear to the degradable polymer composition to induce formation of a gravel pack from the degradable polymer composition;
a method for monitoring a parameter of a subterranean formation, the method comprising introducing a sensing tool to a wellbore, wherein the sensing tool comprises a generally tubular body and is configured to detect a parameter of the subterranean formation; positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device;
a method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size;
a method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent to the tapered face; and contacting the swellable material with a swelling fluid, thereby swelling the swellable material and preventing substantially all fluids from flowing past the swellable material after the swellable material has swelled;
a method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component;
a method of treating a subterranean formation penetrated by a wellbore comprising a formation surface, the method comprising injecting into the formation a fluid comprising a viscosifled fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection;
a method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators;
wherein the polyamide-poly(phenylene ether) composition comprises, based on the total weight of the polyamide-poly(phenylene ether) composition,
35 to 80 weight percent of a polyamide, and
20 to 65 weight percent of a poly(phenylene ether).

2. The method of claim 1, wherein the polyamide is selected from the group consisting of polyamide-6, polyamide-6,6, polyamide-4,6, polyamide-11, polyamide-12, polyamide-6,10, polyamide-6,12, polyamide-6/6,6, polyamide-6/6,12, polyamide-MXD,6, polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, polyamide-9T, and combinations thereof.

3. The method of claim 1, wherein the polyamide comprises polyamide-6,6.

4. The method of claim 1, wherein the poly(phenylene ether) comprises repeating structural units having the formula 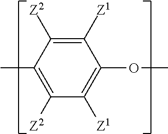
wherein each occurrence of Z¹ is independently halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl; and each occurrence of Z² is independently hydrogen, halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl.

5. The method of claim 1, wherein the poly(phenylene ether) comprises 2,6-dimethyl-1,4-phenylene ether units, 2,3,6-trimethyl-1,4-phenylene ether units, or a combination thereof.

6. The method of claim 1, wherein the polyamide-poly(phenylene ether) composition further comprises 10 to 35 weight percent of an impact modifier selected from the group consisting of rubber-modified polystyrenes, polystyrene-polybutadiene-polystyrene triblock copolymers, and combinations thereof.

7. The method of claim 1, wherein the polyamide-poly(phenylene ether) composition further comprises 5 to 40 weight percent of a mineral filler selected from the group consisting of wollastonite, talc, mica, clay, and combinations thereof.

8. The method of claim 1,
wherein the polyamide-poly(phenylene ether) composition is the product of melt blending components comprising
50 to 69.5 weight percent of polyamide-6,6,
30 to 49.5 weight percent of poly(2,6-dimethyl-1,4-phenylene ether), and
0.5 to 2 weight percent of a compatibilizing agent for the polyamide-6,6 and the poly(2,6-dimethyl-1,4-phenylene ether).

9. The method of claim 1, wherein the method is the method of propping a fracture in a subterranean formation, the method comprising introducing a first proppant and a second proppant into the fracture, wherein the first proppant comprises the polyamide-poly(phenylene ether) composition and is capable of swelling and/or dissolving in a liquid hydrocarbon, and wherein the second proppant neither swells nor dissolves in the liquid hydrocarbon.

10. The method of claim 1, wherein the method is the method of increasing the conductivity of a propped fracture, the method comprising introducing a proppant into the fracture to form the propped fracture, wherein the proppant comprises the polyamide-poly(phenylene ether) composition; and introducing a displacement fluid into the propped fracture, thereby displacing a portion of the proppant and forming additional channels for flow of formation fluids.

11. The method of claim 1, wherein the method is the method of decreasing the conductivity of a fluid loss zone, the method comprising introducing into the fluid loss zone particles comprising the polyamide-poly(phenylene ether) composition; and introducing into the fluid loss zone a fluid capable of swelling the particles, thereby reducing the conductivity of the fluid loss zone.

12. The method of claim 1, wherein the method is the method of isolating a first fracture zone of a deviated well bore from an adjacent second fracture zone of the deviated well bore, wherein the deviated well bore comprises a downstream end and an upstream end, and wherein the first fracture zone is located closer to the downstream end than is the second fracture zone, the method comprising substantially filling the first fracture zone with a filling composition comprising a particulate comprising the polyamide-poly(phenylene ether) composition and having a specific gravity less than or equal to 1.3.

13. The method of claim 1, wherein the method is the method of propping a fracture in a subterranean formation, the method comprising introducing a proppant into the fracture, wherein the proppant comprises a shell comprising the polyamide-poly(phenylene ether) composition, which is capable of dissolving in a liquid hydrocarbon, and a core consisting essentially of a material that is substantially insoluble in the liquid hydrocarbon; and
introducing a liquid hydrocarbon into the fracture, thereby dissolving the proppant shell.

14. The method of claim 1, wherein the method is the method of forming a gravel pack, the method comprising combining the polyamide-poly(phenylene ether) composition, a viscosifier, and a solvent to form a degradable polymer composition; allowing the degradable polymer composition to at least partially plasticize; and applying sufficient shear to the degradable polymer composition to induce formation of a gravel pack from the degradable polymer composition.

15. The method of claim 1, wherein the method is the method for monitoring a parameter of a subterranean formation, the method comprising introducing a sensing tool to a wellbore, wherein the sensing tool comprises a generally tubular body and is configured to detect a parameter of the subterranean formation; positioning the sensing tool in a position corresponding to a surface of the wellbore by swelling a swellable material comprising the polyamide-poly(phenylene ether) composition, wherein the swellable material is disposed on an exterior surface of the generally tubular body; and detecting a parameter of the subterranean formation with the sensing device.

16. The method of claim 1, wherein the method is the method of reducing the production of particulate material from a well that traverses a hydrocarbon-bearing subterranean formation, the method comprising introducing to well a swellable filter medium comprising the polyamide-poly(phenylene ether) composition, the swellable filter medium being operable to allow fluid flow and reduce flow of particulates having a predetermined size.

17. The method of claim 1, wherein the method is the method of preventing fluid flow past a tapered face of a mill diverter in a wellbore, the method comprising: positioning the mill diverter in the wellbore, wherein the mill diverter comprises a body, the tapered face of which is located at one end of the body, and a swellable material comprising the polyamide-poly(phenylene ether) composition and being positioned circumferentially around the body of the mill diverter adjacent, to the tapered face; and contacting the swellable material with a swelling fluid, thereby swelling the swellable material and preventing substantially all fluids from flowing past the swellable material after the swellable material has swelled.

18. The method of claim 1, wherein the method is the method of making a connection in hydrocarbon production equipment, the method comprising positioning at least a portion of a receiving component about at least a portion of an insertable component; providing a swellable element within a circumferential space defined by the at least a portion of the receiving component and the at least a portion of the insertable component, wherein the swellable element comprises the polyamide-poly(phenylene ether) composition; and contacting the swellable element with a swelling fluid, thereby swelling the swellable element and forming a connection between the receiving component and the insertable component.

19. The method of claim 1, wherein the method is the method of treating a subterranean formation penetrated by a wellbore comprising a formation surface, the method comprising injecting into the formation a fluid comprising a viscosified fluid and a solid additive comprising particles sufficiently small to pass into formation pores, wherein the solid additive comprises the polyamide-poly(phenylene ether) composition; and allowing the solid additive to degrade into a material soluble in a fluid in the pores after the injection.

20. The method of claim 1, wherein the method is the method comprising using an oilfield element in an oilfield operation, wherein the oilfield element comprises the polyamide-poly(phenylene ether) composition, and wherein the oilfield element is selected from the group consisting of zonal isolation tool elastomeric elements, packer elements, protector bags, blow out preventer elements, self-healing cements, proppants, gravel packing agents, O-rings, T-rings, electrical submersible pump seal sections, electrical submersible pump protectors, centralizers, hangers, plugs, plug catchers, pipes, pipe liners, check valves, universal valves, spotting valves, differential valves, circulation valves, equalizing valves, safety valves, fluid flow control valves, connectors, disconnect tools, tanks, downhole filters, downhole antenna elements, bottom hole assembly elements, motorheads, Moineau motor stators, retrieval and fishing tools, seal assemblies, snap latch assemblies, anchor latch assemblies, shear-type anchor latch assemblies, diverter balls, fracturing elements, fire-resistant boards, fire-resistant blocks, fire-resistant blankets, and no-go locators.
